(19) United States
(12) Patent Application Publication
(10) Pub. No.: US 2025/0352315 A1
(43) Pub. Date: Nov. 20, 2025

(54) ELECTRIC TOOTHBRUSH CONTROL DEVICE, ELECTRIC TOOTHBRUSH AND CONTROL METHOD

(71) Applicant: Shenzhen Baolijie Technology Co., Ltd., Shenzhen (CN)

(72) Inventors: Huajie He, Shenzhen (CN); Mingfeng He, Shenzhen (CN); Shuai Yuan, Shenzhen (CN)

(21) Appl. No.: 19/192,270

(22) Filed: Apr. 28, 2025

Related U.S. Application Data
(63) Continuation of application No. PCT/CN2025/077965, filed on Feb. 19, 2025.

(30) Foreign Application Priority Data
May 16, 2024 (CN) 202410609004.3

(51) Int. Cl. A61C 17/22; A61C 17/34

(52) U.S. Cl. CPC A61C 17/221; A61C 17/3481

(57) ABSTRACT

An electric toothbrush control device, an electric toothbrush, and a control method are provided. In the control device, a control module is connected to a motor drive circuit, the motor drive circuit is connected to a motor module. A control module generates a corresponding motor drive signal in response to a mode command carrying a working mode. The working mode includes a swing mode, a vibration mode, and an oscillation mode. The motor drive circuit drives a motor module to operate in the working mode in response to the motor drive signal, solving the problem that high-frequency vibration is only relied on to realize tooth cleaning, and tooth parts to be cleaned are easy to be omitted, resulting in incomplete tooth cleaning.

### CROSS-REFERENCE TO RELATED APPLICATION

This application claims priority to Chinese Patent Application No. 202410609004.3, filed to China National Intellectual Property Administration (CNIPA) on May 16, 2024, entitled “ELECTRIC TOOTHBRUSH CONTROL DEVICE, ELECTRIC TOOTHBRUSH AND CONTROL METHO”. The entire contents of the above-mentioned application are incorporated herein by reference.

### TECHNICAL FIELD

The disclosure relates to the technical field of toothbrushes, and more particularly to an electric toothbrush control device, an electric toothbrush and a control method.

### BACKGROUND

Vibration toothbrushes in the related art generate high-frequency vibration through a vibration motor to achieve tooth cleaning. When a user uses an electric vibration toothbrush for a long time, it is easy to develop a habit of cleaning teeth by relying only on the high-frequency vibration of the electric vibration toothbrush without manual brushing. However, the vibration range of the existing electric vibration toothbrush is small. If the vibration toothbrush is used to clean the teeth according to the above cleaning habits for a long time, it is easy to miss tooth parts that need to be cleaned, resulting in incomplete tooth cleaning.

### SUMMARY

The disclosure provides an electric toothbrush control device, an electric toothbrush and a control method, which are used to solve problems that the related art only relies on high-frequency vibration to realize tooth cleaning, and tooth parts to be cleaned are easy to be omitted, resulting in incomplete tooth cleaning.

In an aspect, the disclosure provides an electric toothbrush control device, which includes: a control module (also referred to as a controller), a motor drive circuit and a motor module.

The motor drive circuit is connected to the motor module.

The control module is connected to the motor drive circuit, and the control module is configured to respond to a mode command carrying a working mode, generate a motor drive signal corresponding to the working mode, and input the motor drive signal into the motor drive circuit. The working mode includes a swing mode, a vibration mode and an oscillation mode.

The motor drive circuit is connected to the motor module, and the motor drive circuit is configured to respond to the motor drive signal and drive the motor module to operate in the working mode.

In an embodiment, when the working mode is the swing mode, the control module is specifically configured to obtain a target low-frequency signal and a carrier signal, and generate a first motor drive signal according to the target low-frequency signal and the carrier signal, and input the first motor drive signal into the motor drive circuit.

The motor drive circuit is specifically configured to generate a first drive current in response to the first motor drive signal, and the first drive current is configured to make a rotor of the motor module center on a balanced position and swing with a preset first swing amplitude and a preset first swing frequency.

In an embodiment, when the working mode is the vibration mode, the control module is specifically configured to obtain a target high-frequency signal and the carrier signal, and generate a second motor drive signal according to the target high-frequency signal and the carrier signal, and input the second motor drive signal into the motor drive circuit.

The motor drive circuit is specifically configured to generate a second drive current in response to the second motor drive signal, and the second drive current is configured to make the rotor of the motor module center on the balanced position and vibrate at a preset first vibration amplitude and a preset first vibration frequency.

In an embodiment, when the working mode is the oscillation mode, the control module is specifically configured to obtain the target high-frequency signal, the target low-frequency signal and the carrier signal, superimpose the target high-frequency signal and the target low-frequency signal to obtain a target modulation signal, generate a third motor drive signal according to the target modulation signal and the carrier signal, and input the third motor drive signal into the motor drive circuit.

The motor drive circuit is specifically configured to generate a third drive current in response to the third motor drive signal, and the third drive current is configured to make the rotor of the motor module center on the balanced position, and swing the preset first swing amplitude and the preset first swing frequency, while making the rotor of the motor module center on a current swing position and vibrate at the preset first vibration amplitude and the preset first vibration frequency.

In an embodiment, the motor drive circuit includes a direct current (DC) power supply and an inverter circuit module.

The DC power supply is connected to a DC side of the inverter circuit module.

An alternating current (AC) output side of the inverter circuit module is connected to a winding of the motor module.

In another aspect, an electric toothbrush is provided, including the electric toothbrush control device as described above.

In still another aspect, the disclosure provides a control method for an electric toothbrush, including:
generating the motor drive signal corresponding to the working mode in response to the mode command carrying the working mode; and the working mode includes the swing mode, the vibration mode and the oscillation mode; and
inputting the motor drive signal into the motor drive circuit to make the motor drive circuit drive the motor module to operate in the working mode.

In an embodiment, when the working mode is the swing mode, the generating the motor drive signal corresponding to the working mode in response to the mode command carrying the working mode includes:
obtaining a target low-frequency signal and a carrier signal, and generating a first motor drive signal according to the target low-frequency signal and the carrier signal; and
inputting the motor drive signal into the motor drive circuit to make the motor drive circuit drive the motor module to operate in the working mode, including:
   inputting the first motor drive signal into the motor drive circuit; making the motor drive circuit respond to the first motor drive signal, and generating a first drive current; wherein the first drive current is configured to make a rotor of the motor module center on a balanced position and swing with a preset first swing amplitude and a preset first swing frequency.

In an embodiment, when the working mode is the vibration mode, the generating the motor drive signal corresponding to the working mode in response to the mode command carrying the working mode includes:
obtaining a target high-frequency signal and the carrier signal, and generating a second motor drive signal according to the target high-frequency signal and the carrier signal; and
inputting the motor drive signal into the motor drive circuit to make the motor drive circuit drive the motor module to operate in the working mode, including:
   inputting the second motor drive signal into the motor drive circuit, making the motor drive circuit respond to the second motor drive signal, and generating a second drive current; wherein the second drive current is configured to make the rotor of the motor module center on the balanced position and vibrate at a preset first vibration amplitude and a preset first vibration frequency.

In an embodiment, when the working mode is the oscillation mode, the generating the motor drive signal corresponding to the working mode in response to the mode command carrying the working mode includes:
obtaining the target high-frequency signal, the target low-frequency signal and the carrier signal, superimposing the target high-frequency signal and the target low-frequency signal to obtain a target modulation signal, and generating a third motor drive signal according to the target modulation signal and the carrier signal; and
inputting the motor drive signal into the motor drive circuit to make the motor drive circuit drive the motor module to operate in the working mode, including:
   inputting the third motor drive signal into the motor drive circuit, making the motor drive circuit respond to the third motor drive signal, and generating a third drive current; wherein the third drive current is configured to make the rotor of the motor module center on the balanced position, and swing the preset first swing amplitude and the preset first swing frequency, while making the rotor of the motor module center on a current swing position and vibrate at the preset first vibration amplitude and the preset first vibration frequency.

It can be seen from the above technical solutions that the disclosure has advantages as follows.

The disclosure provides the electric toothbrush control device, which includes the control module, the motor drive circuit and the motor module. The motor drive circuit is connected to the motor module. The control module is connected to the motor drive circuit to respond to the mode command carrying the working mode, generate the motor drive signal corresponding to the working mode, and input the motor drive signal into the motor drive circuit. The working mode includes the swing mode, the vibration mode and the oscillation mode. The motor drive circuit is connected to the motor module to respond to the motor drive signal and drive the motor module to operate in the working mode.

In the disclosure, the control module is connected to the motor drive circuit to respond to the mode command carrying the working mode, generate the motor drive signal corresponding to the working mode, and input the motor drive signal into the motor drive circuit, thus obtaining the motor drive signal of different working modes for controlling the motor module. The motor drive circuit is connected to the motor module to respond to the motor drive signal and drive the motor module to operate in the working mode. The working mode of the motor module of the disclosure includes the swing mode, the vibration mode and the oscillation mode. Therefore, the disclosure can be targeted to generate different motor drive signals of different working modes. It realizes the adjustment and switching of the working mode of the motor module, thus providing users with a variety of rich functional modes. When in use, users can switch the functional modes according to the actual needs, so as to fully and comprehensively clean the teeth, avoiding the problems that the related art only relies on high-frequency vibration to realize tooth cleaning, and tooth parts to be cleaned are easy to be omitted, resulting in incomplete tooth cleaning.

The disclosure also provides the control method for the electric toothbrush, which generates the motor drive signal corresponding to the working mode by responding to the mode command carrying the working mode. The working mode includes the swing mode, the vibration mode and the oscillation mode. By inputting the motor drive signal into the motor drive circuit, the motor drive circuit drives the motor module in the working mode, which solves the problem that the related art only relies on high-frequency vibration to realize tooth cleaning, and tooth parts to be cleaned are easy to be omitted, resulting in incomplete tooth cleaning.

### BRIEF DESCRIPTION OF DRAWINGS

In order to more clearly illustrate embodiments of the disclosure or technical solutions in the related art, the following will briefly introduce drawings used in the description of the embodiments or the related art. Apparently, the drawings in the following description are only some embodiments of the disclosure. For those skilled in the art, without making creative efforts, other drawings can also be obtained based on these drawings.

FIG. 1 illustrates a schematic structural diagram of an electric toothbrush control device according to an embodiment of the disclosure.

FIG. 2 illustrates a schematic two-dimensional sectional structural diagram of a motor module according to an embodiment of the disclosure.

FIG. 3 illustrates a schematic structural diagram of a motor drive circuit according to an embodiment of the disclosure.

FIG. 4 illustrates a schematic waveform diagram of a motor drive signal according to an embodiment of the disclosure.

FIG. 5 illustrates a schematic waveform diagram of a superposition of a target high-frequency signal and a target low-frequency signal according to an embodiment of the disclosure.

FIG. 6 illustrates a schematic waveform diagram of a drive current according to an embodiment of the disclosure.

FIG. 7 illustrates a schematic two-dimensional sectional structural diagram of a motor module according to another embodiment of the disclosure.

FIG. 8 illustrates a schematic two-dimensional sectional structural diagram of a motor module according to still another embodiment of the disclosure.

FIG. 9 illustrates a schematic diagram of an operation flow of the electric toothbrush control device according to the embodiment of the disclosure.

FIG. 10 illustrates a flowchart of steps of a control method for an electric toothbrush according to an embodiment of the disclosure.

### DETAILED DESCRIPTION OF EMBODIMENTS

Embodiments of the disclosure provide an electric toothbrush control device, an electric toothbrush, and a control method, which are used to solve the problems that the related art only relies on high-frequency vibration to realize tooth cleaning, and tooth parts to be cleaned are easy to be omitted, resulting in incomplete tooth cleaning.

In order to make purposes, characteristics and advantages of the disclosure more obvious and understandable, technical solutions in the embodiments of the disclosure are clearly and completely described in combination with the drawings attached to the embodiments of the disclosure. Apparently, the embodiments described below are only a part of the embodiments of the disclosure, but not all of the embodiments. Based on the embodiments of the disclosure, all other embodiments obtained by those skilled in the field without making creative labor fall within the scope of protection of the disclosure.

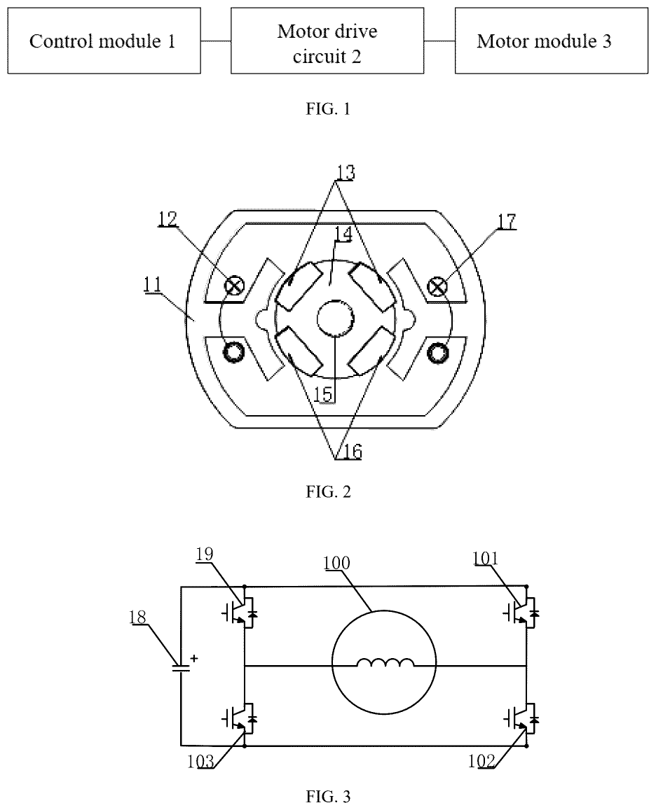

Referring to FIG. 1, the disclosure provides an electric toothbrush control device, which includes: a control module 1, a motor drive circuit 2, and a motor module 3. The motor drive circuit 2 is connected to motor module 3. The control module 1 is connected to the motor drive circuit 2, and the control module is configured to respond to a mode command carrying a working mode, generate a motor drive signal corresponding to the working mode, and input the motor drive signal into the motor drive circuit 2. The working mode includes a swing mode, a vibration mode and an oscillation mode. The motor drive circuit 2 is connected to the motor module 3, and the motor drive circuit 2 is configured to respond to the motor drive signal and drive the motor module 3 to operate in the working mode.

It should be noted that the swing mode means that the motor module 3 swings with a preset first swing amplitude and a preset first swing frequency. The vibration mode means that the motor module 3 vibrates at a preset first vibration amplitude and a preset first vibration frequency. The oscillation mode means that the motor module 3 swings at the preset first swing amplitude and the preset first swing frequency, and at the same time vibrates at the preset first vibration amplitude and the preset first vibration frequency. A relationship among the above three working modes is “or”. The motor module 3 is used to drive a brush head of the electric toothbrush to move accordingly. It is understandable that the movement of the brush head is consistent with the movement of the motor module 3.

In practical application, the working principle of this embodiment is as follows.

The user inputs the mode command with the working mode to the control module 1. After receiving the mode command, the control module 1 analyzes the mode command and obtains the corresponding working mode. Among them, the working mode includes the swing mode, the vibration mode and the oscillation mode. Afterwards, the motor drive signal corresponding to the working mode is generated by the control module 1, such as the motor drive signal corresponding to the swing mode, the motor drive signal corresponding to the vibration mode, and the motor drive signal corresponding to the oscillation mode; the control module 1 inputs the corresponding motor drive signal into the motor drive circuit 2, the motor drive circuit 2, after receiving the motor drive signal, responds to the motor drive signal, and controls the motor module 3 to operate in the corresponding working mode, to realize tooth cleaning.

For example, when the received motor drive signal is the motor drive signal corresponding to the oscillation mode, the motor drive circuit 2 controls the motor module 3 to operate in the oscillation mode, so that the brush head of the electric toothbrush swings according to the first swing amplitude and the first swing frequency, and at the same time vibrates with the first vibration amplitude and the first vibration frequency. Thus, the brush head of the electric toothbrush can brush the clean tooth with the preset first swing amplitude and the preset first swing frequency to realize the simulation of the user's manual brushing and increase the cleaning area. At the same time, it can also vibrate with the preset first vibration amplitude and the preset first vibration frequency to strengthen the cleaning force, thus improving the cleanliness of tooth parts to be cleaned. It avoids the situation where the existing vibration electric toothbrushes, due to their small vibration range, are difficult to simulate the brushing action when users brush their teeth manually, resulting in incomplete cleaning of the teeth.

In this embodiment, the control module 1 is connected to the motor drive circuit 2 to respond to the mode command carrying the working mode, generate the motor drive signal corresponding to the working mode, and input the motor drive signal into the motor drive circuit 2, thus obtaining the motor drive signal of different working modes for controlling the motor module 3. The motor drive circuit 2 is connected to the motor module 3 to respond to the motor drive signal, drive the motor module 3 to operate in the working mode, and realize the adjustment of the working mode of the motor module 3. Moreover, in the disclosure, the working mode of the motor module 3 includes the swing mode, the vibration mode, and the oscillation mode, it provides users with a variety of rich modes of use, and the working mode of the motor module 3 can be switched according to the user's needs, thus avoiding that the electric toothbrush in the related art only relies on high-frequency vibration to clean teeth, which is easy to miss the teeth to be cleaned. In the disclosure, the operation is simple, the learning cost of the user is reduced, the use threshold of the user is lowered, and the use experience of the user is improved.

It should be noted that the motor module 3 of the disclosure can be a motor containing a pair of pole structures. For example, for example, the structure of the motor module 3 may be a limited angle motor structure as shown in FIG. 2, and the motor module 3 may include an integrally formed stator core 11 as shown in FIG. 2.

Two sides of the stator core 11 are respectively provided with a left stator tooth winding 12 and a right stator tooth winding 17.

A middle part of the stator core 11 is provided with a motor rotor 14.

A middle part of the motor rotor 14 is provided with a rotating shaft 15.

A circumference of the motor rotor 14 is provided with first rotor permanent magnets 13 and second rotor permanent magnets 16.

The left stator tooth winding 12 and the right stator tooth winding 17 are wound in series and connected to an AC output side of the motor drive circuit 2.

In FIG. 2, the left stator tooth winding 12 and the right stator tooth winding 17 are single-phase winding, which are wound in series in the two sides of the stator core 11. Therefore, the left stator tooth winding 12 and the right stator tooth winding 17 have the same current direction. The first rotor permanent magnets 13 and the second rotor permanent magnets 16 are fixed to the motor rotor 14 by a strong adhesive.

The working principle is as follows.

The motor drive circuit 2 responds to the motor drive signal and outputs the corresponding drive current to the left stator tooth winding 12 and the right stator tooth winding 17, so that the motor rotor 14 moves according to the corresponding working mode under the action of the first rotor permanent magnets 13 and the second rotor permanent magnets 16.

In this embodiment, the motor module 3 with the above structure is adopted to simplify the control mode of the driving motor, so that the driving mode of the motor module 3 is simpler and more convenient, and the problems that the existing sweeping-vibration type electric toothbrush is driven by a servo motor, the control mode is complex, the requirements on the motor and the driving hardware thereof are high, the production cost is high, and the reliability is lower than that of a vibration-type electric toothbrush are avoided.

In a specific embodiment, the magnetizing direction of the first rotor permanent magnets 13 are toward the outside of the motor rotor 14, and the magnetizing direction of the second rotor permanent magnets 1 are toward the inside of the motor rotor 14.

It should be noted that, as shown in FIG. 2, the number of the first rotor permanent magnets 13 may be two, the number of the second rotor permanent magnets 16 may be two, and the arrangement of the first rotor permanent magnets 13 and the second rotor permanent magnets 16 is N-N-S-S. Taking FIG. 2 as an example, an end of each first rotor permanent magnet 13 close to the inner side of the motor rotor 14 is an N pole, and an end of each second rotor permanent magnet 16 close to the inner side of the moto rotor 14 is an S pole. It can be understood that the magnetizing directions of all the first rotor permanent magnets 13 are toward the outside of the motor rotor 14, and the magnetizing directions of all the second rotor permanent magnets 16 are toward the inside of the motor rotor 14.

Specifically, the magnetization method for the first rotor permanent magnets 13 and the second rotor permanent magnets 16 includes parallel magnetization.

It should be understood that the motor structure shown in FIG. 2 is only a detailed description of an embodiment of the motor module 3 according to the disclosure, and is not limited to this type of motor. The control principle of the control module 1 of the disclosure is applicable to the motor having the limited angle motor structure similar to that shown in FIG. 2.

In a specific embodiment, the motor drive circuit 2 includes a DC power supply 18 and an inverter circuit module.

The DC power supply 18 is connected to a DC side of the inverter circuit module.

An AC output side of the inverter circuit module is connected to a winding 100 of the motor module 3.

It should be noted that the DC power supply 18 is used to provide direct current power. In this embodiment, the inverter circuit module can adopt a single-phase full-bridge inverter drive circuit, as shown in FIG. 3. The drive circuit is a H-bridge drive circuit, including a first bridge arm transistor 19, a second bridge arm transistor 101, a third bridge arm transistor 102 and a fourth bridge arm transistor 103. The first bridge arm transistor 19, the second bridge arm transistor 101, the third bridge arm transistor 102 and the fourth bridge arm transistor are connected to reverse diodes to ensure normal continuation of current.

The connection of the first bridge arm transistor 19 and the third bridge arm transistor 102 is connected to the winding 100 of the motor module 3, and the connection of the second bridge arm transistor 101 and the fourth bridge arm transistor 103 is connected to the winding 100 of the motor module 3. When the motor module 3 adopts the motor structure as shown in FIG. 2, the winding 100 includes the left stator tooth winding 12 and the right stator tooth winding 17.

The working principle of this embodiment is as follows.

The control module 1 outputs the motor drive signal to the first bridge arm transistor 19, the second bridge arm transistor 101, the third bridge arm transistor 102 and the fourth bridge arm transistor 103 to adjust the on and off states of the first bridge arm transistor 19, the second bridge arm transistor 101, the third bridge arm transistor 102 and the fourth bridge arm transistor 103. The change of the on and off states of the first bridge arm transistor 19, the second bridge arm transistor 101, the third bridge arm transistor 102 and the fourth bridge arm transistor 103 will change the voltage at both ends of the winding 100 of the motor module 3, thus changing the current of the winding 100 of the motor module 3. Further, the rotor of the motor module 3 moves accordingly with the changing drive current waveform, so that the motor module 3 can run in the corresponding working mode.

Among them, the relationship between the on and off states of the first bridge arm transistor 19, the second bridge arm transistor 101, the third bridge arm transistor 102 and the fourth bridge arm transistor 103 is as follows: the first bridge arm transistor 19 and the third bridge arm transistor 102 are turned on and off simultaneously; and the second bridge arm transistor 101 and the fourth bridge arm transistor 103 are turned on and off simultaneously.

In a specific embodiment, the motor drive signal includes a first motor drive signal, a second motor drive signal, and a third motor drive signal.

Among them, the swing mode corresponds to the first motor drive signal, the vibration mode corresponds to the second motor drive signal, and the oscillation mode corresponds to the third motor drive signal. The first motor drive signal, the second motor drive signal and the third motor drive signal can be pulse width modulation (PWM) signals.

In a specific embodiment, when the working mode is the swing mode, the control module 1 is specifically used to obtain a target low-frequency signal and a carrier signal, generate the first motor drive signal according to the target low-frequency signal and the carrier signal, and input the first motor drive signal into the motor drive circuit 2.

The motor drive circuit 2 is specifically used to generate the first drive current in response to the first motor drive signal. The first drive current is used to make the rotor of the motor module 3 center on a balanced position and swing at a preset first swing amplitude and a preset first swing frequency.

It should be noted that the target low-frequency signal can be obtained by the control chip of the control module 1 by looking up the table. The carrier signal can adopt a high-frequency triangular carrier signal. The high-frequency triangular carrier signal can be provided by the counter in the control chip center alignment mode of the control module 1. Therefore, this embodiment does not require an external signal source and reduces the device cost. When the motor module 3 adopts the motor structure as shown in FIG. 2, the rotor of the motor module 3 is the motor rotor 14.

Taking the motor structure shown in FIG. 2 as an example, the working principle of this embodiment is explained as follows.

In this embodiment, the process of the control module 1 generating the first motor drive signal according to the target low-frequency signal and the carrier signal by adopting a preset modulation method, taking the target low-frequency signal as a modulation signal, the target low-frequency signal and the carrier signal are modulated to obtain a PWM signal. Thus, the on and off states of the first bridge arm transistor 19, the second bridge arm transistor 101, the third bridge arm transistor 102 and the fourth bridge arm transistor 103 are adjusted by the PWM signal, and the voltage at both ends of the winding 100 is changed, thus changing the current of the winding 100 (that is, the first drive current). Therefore, under the action of the magnetic field built by the first rotor permanent magnets 13 and the second rotor permanent magnets 16, the motor rotor 14 swings according to the first swing amplitude and the first swing frequency.

The values of the first swing amplitude and the first swing frequency can be set according to the actual needs, and the values of the first swing amplitude and the first swing frequency can be adjusted by modulating the amplitude and frequency of the signal, so that the values of the first swing amplitude and the first swing frequency can reach the actual required values.

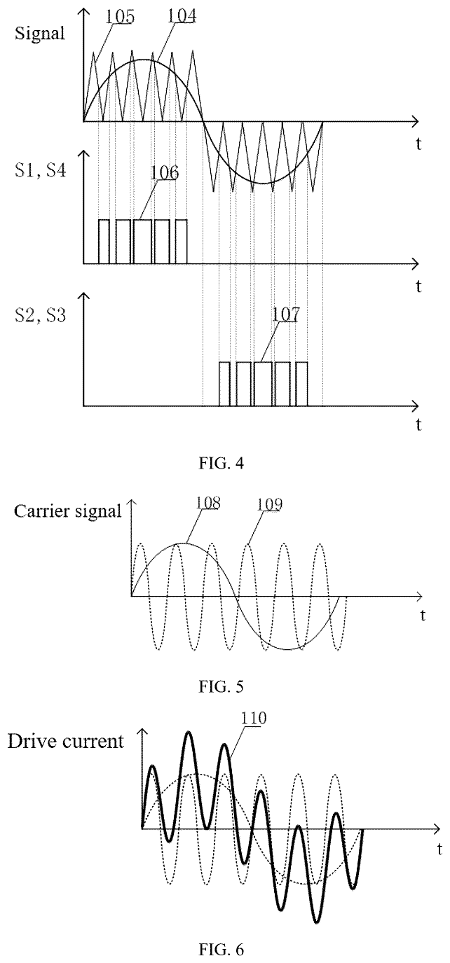

In one example, this example takes sinusoidal pulse width modulation (SPWM) modulation method and sine wave signal as modulation signal as an example. As shown in FIG. 4, 104 is a sinusoidal modulation signal, 105 is a high-frequency triangular carrier signal, 106 and 107 are generated PWM signals, S1 and S4 correspond to the first bridge arm transistor 19 and the third bridge arm transistor 102 respectively, and S2 and S3 correspond to the second bridge arm transistor 101 and the fourth bridge arm transistor 103 respectively. When the value of the sinusoidal modulation signal 104 is higher than the high-frequency triangular carrier signal 105, the PWM output is generated to be a high level, and the corresponding transistor is controlled to be turned on. As can be seen from FIG. 4, when the sinusoidal modulation signal 104 is greater than 0, the corresponding PWM signal 106 controls the on and off states of the first bridge arm transistor 19 and the third bridge arm transistor 102. When the sinusoidal modulation signal 104 is less than 0, the PWM signal 107 controls the on and off states of the second bridge arm transistor 101 and the fourth bridge arm transistor 103. According to the principle of pulse width modulation, the change of the on and off states of the first bridge arm transistor 19, the second bridge arm transistor 101, the third bridge arm transistor 102, and the fourth bridge arm transistor 103 leads to the change of the voltage signal generated at both ends of the winding 100, and the voltage change at both ends of the winding 100 will cause the current change. At this time, the current change waveform of the winding 100 is equivalent to the sinusoidal modulation signal 104, and the current waveform of the winding 100 is also the first motor drive current. Therefore, the change of current of the winding 100 causes the motor rotor 14 to be centered on the balanced position and swing with the preset first swing amplitude and the preset first swing frequency.

Therefore, in this embodiment, by adjusting the amplitude and frequency of the sinusoidal modulation signal 104, the first motor drive current with different amplitude and frequency can be obtained.

When the working mode is the vibration mode, the control module 1 is specifically used to obtain the target high-frequency signal and the carrier signal, generate the second motor drive signal according to the target high-frequency signal and the carrier signal, and input the second motor drive signal into the motor drive circuit 2.

The motor drive circuit 2 is specifically used to respond to the second motor drive signal to generate the second drive current. The second drive current is used to center the rotor of the motor module 3 at the balanced position and vibrate at the preset first vibration amplitude and the preset first vibration frequency.

It should be noted that the target high-frequency signal can be obtained by the control chip of the control module 1 by looking up the table.

Taking the motor structure shown in FIG. 2 as an example, the working principle of this embodiment is explained as follows.

The process of the control module 1 generating the first motor drive signal according to the target low-frequency signal and the carrier signal by adopting a preset modulation method, taking the target low-frequency signal as a modulation signal, the target low-frequency signal and the carrier signal are modulated to obtain a PWM signal. Thus, the on and off states of the first bridge arm transistor 19, the second bridge arm transistor 101, the third bridge arm transistor 102 and the fourth bridge arm transistor 103 are adjusted by the PWM signal, and the voltage at both ends of the winding 100 is changed, thus changing the current of the winding 100 (that is, the second drive current). Therefore, under the action of the magnetic field built by the first rotor permanent magnets 13 and the second rotor permanent magnets 16, the motor rotor 14 swings according to the first vibration amplitude and the first vibration frequency.

The generation principle of the second drive current is similar to the generation principle of the first drive current, which can be referred to the above description, and will not be repeated here.

The values of the first vibration amplitude and the first vibration frequency can be set according to the actual needs, and the values of the first vibration amplitude and the first vibration frequency can be adjusted by modulating the amplitude and frequency of the signal, so that the values of the first vibration amplitude and the first vibration frequency can reach the actual required values.

In a specific embodiment, when the working mode is the oscillation mode, the control module 1 is specifically used to acquire the target high-frequency signal, the target low-frequency signal and the carrier signal, and superimpose the target high-frequency signal and the target low-frequency signal to obtain the target modulation signal, generate the third motor drive signal according to the target modulation signal and the carrier signal, and input the third motor drive signal into the motor drive circuit 2.

The motor drive circuit 2 is specifically used to respond to the third motor drive signal and generate the third drive current. The third drive current is used to make the rotor of the motor module 3 center on the balanced position and swing at the first swing amplitude and the first swing frequency, make the rotor of the motor module 3 center on the current swing position and vibrate at the first vibration amplitude and the first vibration frequency.

It should be noted that in this embodiment, when the working mode is the oscillation mode, the rotor of the motor module 3 swing and vibrate at the same time, so as to simulate the cleaning part of the user's manual brushing, improve the cleanliness of the teeth, and expand the cleaning area. Since the position of the rotor of the motor module 3 will change during the vibration process of the motor module 3, the motor module 3 in this embodiment vibrates with the real-time swing position of the rotor as the center, and the current swing position refers to the position of the motor rotor 14 obtained in real time.

Taking the motor structure shown in FIG. 2 as an example, the working principle of this embodiment is explained as follows.

When the working mode is the oscillation mode, the control module 1 superposes the target high-frequency signal and target low-frequency signal based on the preset modulation method to obtain the target modulation signal, and the target modulation signal and the high-frequency carrier signal are modulated to obtain the PWM signal by adopting the preset modulation method. At this time, the PWM signal is the third motor drive signal. Then, the third drive signal is input into each transistor in the motor drive circuit 2, each transistor is switched on or off, so as to change the current of the winding 100. At this time, the current of winding 100 is the third drive current. According to the principle of pulse width modulation, the waveform of the third drive current is the same as that of the target modulation signal, and it is also the superposition of the high-frequency current signal and the low-frequency current signal. Therefore, under the action of the third drive current and the magnetic field of the first rotor permanent magnets 13 and the second rotor permanent magnets 16, the motor rotor 14 is centered on the balanced position and swings at the first swing amplitude and the first swing frequency, while the motor rotor 14 is centered on the current swing position and vibrates at the first vibration amplitude and the first vibration frequency.

In an embodiment, the superimposed waveform of the target high-frequency signal 108 and the target low-frequency signal 109 is shown in FIG. 5.

In an embodiment, the preset modulation method can adopt but is not limited to SPWM, space vector pulse width modulation (SVPWM), discontinuous pulse width modulation (DPWM), etc., which can carry out high and low-frequency signal modulation, as well as signal modulation that can produce a high-frequency signal superimposed with a low-frequency signal.

In an embodiment, the target high-frequency signal and target low-frequency signal may be, but not limited to, a sine wave, a sawtooth wave, a steamed bun wave. The frequency of the target high-frequency signal and the target low-frequency signal can be selected according to the actual situation.

Taking that the target high-frequency signal 108 and the target low-frequency signal 109 both adopt sine waves and the working mode is the swing mode as an example, as shown in FIG. 5, 108 is the target high-frequency signal, 109 is the target low-frequency signal, and the superposed signal acts on the motor drive circuit 2, the drive current generated on the winding 100 of the motor is shown as 110 in FIG. 6.

In order to more clearly illustrate the wide applicability of the motor module 3 of the disclosure, two embodiments of the motor module 3 are added below.

### Embodiment 1

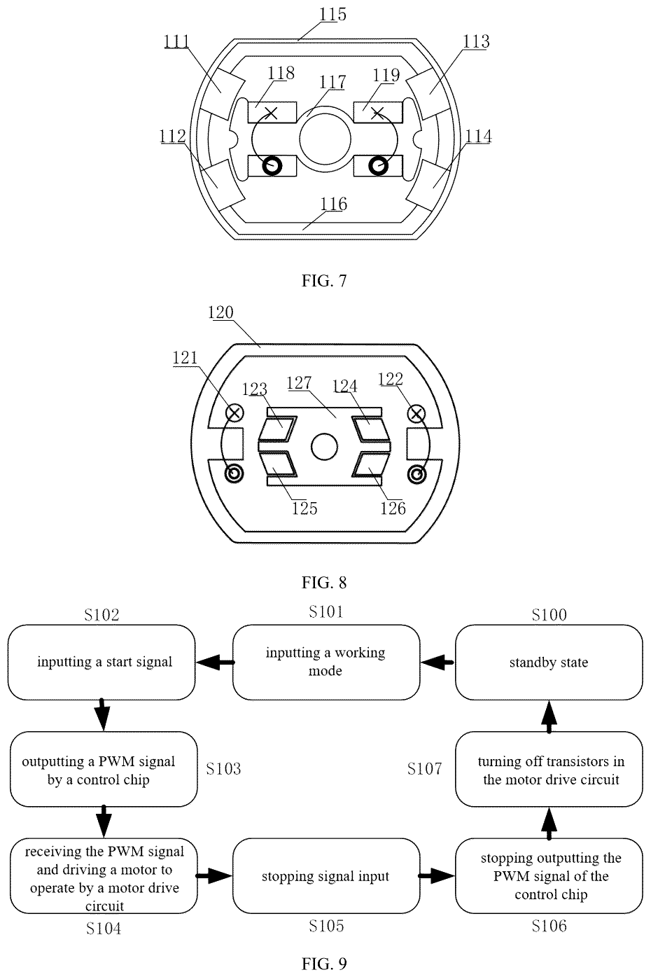

The motor module 3 may adopt a motor structure as shown in FIG. 7 different from that shown in FIG. 2. The motor module 3 may specifically include a first stator permanent magnet 111, a second stator permanent magnet 112, a third stator permanent magnet 113, a fourth stator permanent magnet 114, a motor housing 115, an internal support structure 116, a motor rotor 117, a first rotor winding 118, and a second rotor winding 119.

In the embodiment 1, the winding 100 of the motor module 3 shown in FIG. 3 is the first rotor winding 118 and the second rotor winding 119. The rotor of the motor module 3 is the motor rotor 117, in which the first stator permanent magnet 111, the second stator permanent magnet 112, the third stator permanent magnet 113, the fourth stator permanent magnet 114 are used to construct the magnetic field environment inside the motor, and their functions are similar to those of the first rotor permanent magnets 13 and the second rotor permanent magnets 16 as shown in FIG. 2.

In this embodiment, the process of the new control method proposed by the disclosure is described as follows.

When the working mode is the swing mode, the control module 1 is specifically used to obtain a target low-frequency signal and a carrier signal, generate a first motor drive signal according to the target low-frequency signal and the carrier signal, and input the first motor drive signal into the motor drive circuit 2.

The motor drive circuit 2 is specifically used to generate a first drive current in response to the first motor drive signal, and the first drive current is used to make the motor rotor 117 center on a balanced position and swing at a preset first swing amplitude and a preset first swing frequency.

When the working mode is the vibration mode, the control module 1 is specifically used to obtain a target high-frequency signal and the carrier signal, generate a second motor drive signal according to the target high-frequency signal and the carrier signal, and input the second motor drive signal into the motor drive circuit 2.

The motor drive circuit 2 is specifically used to generate a second drive current in response to the second motor drive signal, and the second drive current is used to make the motor rotor 117 center on the balanced position and vibrate at a preset first vibration amplitude and a preset first vibration frequency.

When the working mode is the oscillation mode, the control module 1 is specifically used to obtain the target high-frequency signal, the target low-frequency signal and the carrier signal, superimpose the target high-frequency signal and target low-frequency signal to obtain a target modulation signal, generate a third motor drive signal according to the target modulation signal and the carrier signal, and input the third motor drive signal into the motor drive circuit 2.

The motor drive circuit 2 is specifically used to generate a third drive current in response to the third motor drive signal. The third drive current is used to make the motor rotor 117 center on the balanced position and swing at the first swing amplitude and the first swing frequency, while making the motor rotor 117 center on a current swing position and vibrate at the first vibration amplitude and the first vibration frequency.

It can be understood that the working principle of the swing mode, the vibration mode and the oscillation mode in the embodiment 1 can be referred to the aforementioned embodiments and will not be described here.

### Embodiment 2

The motor module 3 can adopt a motor structure as shown in FIG. 8 different from that shown in FIG. 2. The motor module 3 may specifically include: a stator 120, a first stator winding 121, a second stator winding 122, a first permanent magnet 123, a second permanent magnet 124, a third permanent magnet 125, a fourth permanent magnet 126, and a motor rotor 127.

In the embodiment 2, the winding 100 of the motor module 3 shown in FIG. 3 is the first stator winding 121 and the second stator winding 122. The rotor of the motor module 3 is the motor rotor 127, in which the first permanent magnet 123, the second permanent magnet 124, the third permanent magnet 125, the fourth permanent magnet 126 are used to construct the magnetic field environment inside the motor, and their functions are similar to those of the first rotor permanent magnets 13 and the second rotor permanent magnets 16 as shown in FIG. 2.

In this embodiment, the process of the new control method proposed by the disclosure is described as follows.

When the working mode is the swing mode, the control module 1 is specifically used to obtain a target low-frequency signal and a carrier signal, generate a first motor drive signal according to the target low-frequency signal and the carrier signal, and input the first motor drive signal into the motor drive circuit 2.

The motor drive circuit 2 is specifically used to generate a first drive current in response to the first motor drive signal, and the first drive current is used to make the motor rotor 127 center on a balanced position and swing at a preset first swing amplitude and a preset first swing frequency.

When the working mode is the vibration mode, the control module 1 is specifically used to obtain a target high-frequency signal and the carrier signal, generate a second motor drive signal according to the target high-frequency signal and the carrier signal, and input the second motor drive signal into the motor drive circuit 2.

The motor drive circuit 2 is specifically used to generate a second drive current in response to the second motor drive signal, and the second drive current is used to make the motor rotor 127 center on the balanced position and vibrate at a preset first vibration amplitude and a preset first vibration frequency.

When the working mode is the oscillation mode, the control module 1 is specifically used to obtain the target high-frequency signal, the target low-frequency signal and the carrier signal, and superimpose the target high-frequency signal and the target low-frequency signal to obtain a target modulation signal, generate a third motor drive signal according to the target modulation signal and the carrier signal, and input the third motor drive signal into the motor drive circuit 2.

The motor drive circuit 2 is specifically used to generate a third drive current in response to the third motor drive signal. The third drive current is used to make the motor rotor 127 center on the balanced position and swing at the first swing amplitude and the first swing frequency, while making the motor rotor 127 center on a current swing position and vibrate at the first vibration amplitude and the first vibration frequency.

It can be understood that the working principle of the swing mode, the vibration mode and the oscillation mode in the embodiment 2 can be referred to the aforementioned embodiments and will not be described here.

It should be emphasized that the motor structure listed in FIG. 2, FIG. 7, FIG. 8 is only an illustrative illustration of the control principle of the control device provided by the disclosure, and is not used to limit the structure of the motor module 3 of the disclosure. The motor module 3 in the embodiment of the disclosure is not limited to the motor of the structure shown in FIG. 2, FIG. 7, and FIG. 8. It can be all motors that contain a pair of pole structures, or it can be similar motors of the structure shown in FIG. 2, FIG. 7, FIG. 8, and so on.

In a specific embodiment, under normal working conditions, the rotor of the motor module 3 will automatically return to the balanced position in the event of a normal power failure, without re-positioning the entire process.

In a practical application embodiment, the operation process of the embodiment of the disclosure is shown in FIG. 9.
S100: the motor module 3 is powered on and in a standby state.
S101: the working mode that receives user input, in which the working mode is divided into the swing mode, the vibration mode and the oscillation mode.
S102: when the working mode is input to the control chip of the control module 1, the control chip generates a start signal.
S103: the control chip generates a modulation signal 104 and the carrier signal 105 corresponding to the working mode, and generates and outputs a PWM control signal according to the modulation signal 104 and the carrier signal 105.
S104: the motor drive circuit 2 receives the PWM control signal, controls each bridge arm transistor in the inverter circuit module, thus generating drive current in the winding of the motor, so that the motor rotor 14 can achieve corresponding movement.
S105: when a stop signal input by the user is received, S106 is performed.
S106: the control chip stops outputting the PWM control signal and executes step S107.
S107: all bridge arm transistors in the motor drive circuit 2 are turned off, and control is transferred to S100 to place the motor in the standby state.

An embodiment of the disclosure also provides an electric toothbrush, including a control device for any of the above embodiments.

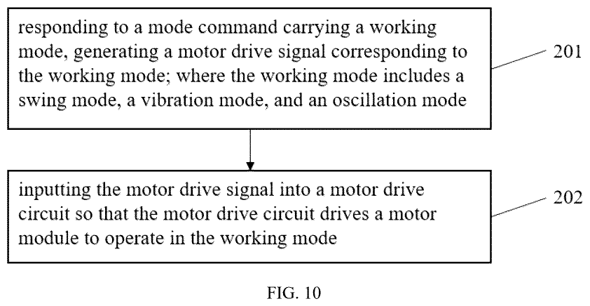

Referring to FIG. 10, an embodiment of the disclosure also provides a control method for an electric toothbrush that is not limited to the three motor structures shown in FIG. 2, FIG. 7, and FIG. 8. The control method can be applied to all motors with a pair of poles and can also be adapted to motors with structures similar to those illustrated in FIG. 2, FIG. 7, and FIG. 8.

Specifically, the control methods include the steps 201 and 202.
201: responding to a mode command carrying a working mode, generating a motor drive signal corresponding to the working mode; where the working mode includes a swing mode, a vibration mode, and an oscillation mode.
202: inputting the motor drive signal into a motor drive circuit so that the motor drive circuit drives a motor module to operate in the working mode.

In this embodiment, the motor drive signal corresponding to the working mode is generated by responding to the mode command carrying the working mode, and the motor drive signal is input into the motor drive circuit, so that the motor drive circuit drives the motor module to operate in the working mode, which solves the problem that the related art only relies on high-frequency vibration to realize tooth cleaning, and tooth parts to be cleaned are easy to be omitted, resulting in incomplete tooth cleaning.

In a specific embodiment, when the working mode is the swing mode, the step 201 specifically includes:
obtaining a target low-frequency signal and a carrier signal, and generate a first motor drive signal according to the target low-frequency signal and the carrier signal.

The step 202 includes:
inputting the first motor drive signal into the motor drive circuit, so that the motor drive circuit generates a first drive current. The first drive current is used to make a rotor of the motor module center on a balanced position, and swing at a preset first swing amplitude and a preset first swing frequency.

In a specific embodiment, when the working mode is the vibration mode, the step 201 specifically includes:
obtaining a target high-frequency signal and the carrier signal, and generate a second motor drive signal according to the target high-frequency signal and the carrier signal.

The step 202 includes:
inputting the second motor drive signal into the motor drive circuit, so that the motor drive circuit generates a second drive current. The second drive current is used to make the rotor of the motor module center on the balanced position, and vibrates at a preset first vibration amplitude and a preset first vibration frequency.

In a specific embodiment, when the working mode is the oscillation mode, the step 201 includes:
obtaining the target high-frequency signal, the target low-frequency signal and the carrier signal, and superimposing the target high-frequency signal and the target low-frequency signal to obtain a target modulation signal, and generate a third motor drive signal according to the target modulation signal and the carrier signal.

The step 202 includes:
inputting the third motor drive signal into the motor drive circuit, so that the motor drive circuit generates a third drive current. The third drive current is used to make the rotor of the motor module center on the balanced position, and swing at the first swing amplitude and the first swing frequency, while making the rotor of the motor module center on a current swing position and vibrate at the first vibration amplitude and the first vibration frequency vibration.

Those skilled in the art can clearly understand that, for the convenience and brevity of description, the specific working processes of the systems, devices and units described above can be referred to the corresponding processes in the foregoing method embodiments, and will not be described here.

In the several embodiments provided in the disclosure, it should be understood that the disclosed systems, devices and methods may be implemented by other means. For example, the device embodiments described above are only illustrative, for example, the division of the unit is only a logical function division, and the actual implementation can have another division, such as multiple units or components can be combined or integrated into another system, or some features can be ignored or not performed. In addition, the coupling or direct coupling or communication connection shown or discussed may be an indirect coupling or communication connection through some interface, device or unit, which may be electrical, mechanical or other forms.

The units described as separate components may or may not be physically separate, and the components displayed as units may or may not be physical units, that is, may be located in one place, or may be distributed to multiple network units. Some or all of the units can be selected according to the actual needs to realize the purpose of the embodiment scheme.

In addition, each functional unit in each embodiment of the disclosure may be integrated in a processing unit, or each functional unit may be physically independent, or two or more functional units may be integrated in one processing unit. The integrated unit can be realized in the form of hardware or software function unit.

The integrated unit may be stored in a computer-readable storage medium if it is realized in the form of a software functional unit and sold or used as a separate product. Based on such an understanding, the technical solution of the disclosure in essence or in part contributes to the related art, or all or part of the technical solution can be embodied in the form of a computer software product stored in a storage medium, which includes multiple instructions for causing a computer device (which can be a personal computer, a server, or a network device, etc.) to perform all or a portion of the steps of the method described in various embodiments of the disclosure. The aforementioned storage media include various media capable of storing program codes, such as a U disk, a mobile hard disk, a read-only memory (ROM), a random-access memory (RAM), a magnetic disk or an optical disk.

The terms “first”, “second”, “third”, “fourth”, etc. in the description of the disclosure and in the accompanying drawings above, if any, are used to distinguish similar objects and are not necessarily used to describe a particular order or sequence. It should be understood that the data used in this way can be interchanged where appropriate, so that the embodiments of the present application described here, for example, can be implemented in a sequence other than those illustrated or described here. In addition, the terms “including” and “having”, and any variations thereof, are intended to cover non-exclusive inclusions, for example, a process, a method, a system, a product or a device including a series of steps or units need not be limited to those steps or units that are clearly listed. Instead, it may include other steps or units that are not clearly listed or are inherent to these processes, methods, products or equipment.

It should also be noted that in the description of the disclosure, it should be noted that the orientation or position relationships indicated by the terms “center”, “up”, “down”, “left”, “right”, “vertical”, “horizontal”, “inside”, “outside”, etc. are based on the orientation or position relationships shown in the attached drawings only for the purpose of facilitating the description of the disclosure and simplifying the description. It is not indicated or implied that the device or element referred to must have a particular orientation, be constructed and operated in a particular orientation, and therefore cannot be construed as a limitation of the disclosure.

The above embodiments are only used to illustrate the technical solutions of the disclosure, not to limit the same. Although the disclosure has been described in detail with reference to the foregoing embodiments, those skilled in the art should understand that the technical solutions described in the foregoing embodiments can still be modified, or some of the technical features thereof can be equivalently substituted. These modifications or substitutions do not make the essence of the corresponding technical solutions deviate from the spirit and scope of the technical solutions of the embodiments of the disclosure.

What is claimed is:

1. An electric toothbrush control device, comprising: a controller, a motor drive circuit and a motor module;
wherein the motor drive circuit is connected to the motor module;
wherein the controller is connected to the motor drive circuit, and the controller is configured to respond to a mode command carrying a working mode, generate a motor drive signal corresponding to the working mode, and input the motor drive signal into the motor drive circuit; and the working mode comprises a swing mode, a vibration mode and an oscillation mode; and
wherein the motor drive circuit is connected to the motor module, and the motor drive circuit is configured to respond to the motor drive signal and drive the motor module to operate in the working mode.

2. The electric toothbrush control device as claimed in claim 1, wherein when the working mode is the swing mode, the controller is specifically configured to obtain a target low-frequency signal and a carrier signal, and generate a first motor drive signal according to the target low-frequency signal and the carrier signal, and input the first motor drive signal into the motor drive circuit; and
the motor drive circuit is specifically configured to generate a first drive current in response to the first motor drive signal, and the first drive current is configured to make a rotor of the motor module center on a balanced position and swing with a preset first swing amplitude and a preset first swing frequency.

3. The electric toothbrush control device as claimed in claim 2, wherein when the working mode is the vibration mode, the controller is specifically configured to obtain a target high-frequency signal and the carrier signal, and generate a second motor drive signal according to the target high-frequency signal and the carrier signal, and input the second motor drive signal into the motor drive circuit; and
the motor drive circuit is specifically configured to generate a second drive current in response to the second motor drive signal, and the second drive current is configured to make the rotor of the motor module center on the balanced position and vibrate at a preset first vibration amplitude and a preset first vibration frequency.

4. The electric toothbrush control device as claimed in claim 3, wherein when the working mode is the oscillation mode, the controller is specifically configured to obtain the target high-frequency signal, the target low-frequency signal and the carrier signal, superimpose the target high-frequency signal and the target low-frequency signal to obtain a target modulation signal, generate a third motor drive signal according to the target modulation signal and the carrier signal, and input the third motor drive signal into the motor drive circuit; and
the motor drive circuit is specifically configured to generate a third drive current in response to the third motor drive signal, and the third drive current is configured to make the rotor of the motor module center on the balanced position, and swing the preset first swing amplitude and the preset first swing frequency, while making the rotor of the motor module center on a current swing position and vibrate at the preset first vibration amplitude and the preset first vibration frequency.

5. The electric toothbrush control device as claimed in claim 1, wherein the motor drive circuit comprises a direct current (DC) power supply and an inverter circuit module;
the DC power supply is connected to a DC side of the inverter circuit module; and
an alternating current (AC) output side of the inverter circuit module is connected to a winding of the motor module.

6. An electric toothbrush, comprising the electric toothbrush control device as claimed in claim 1.

7. A control method for an electric toothbrush, applied to the electric toothbrush control device as claimed in in claim 1, comprising:
generating the motor drive signal corresponding to the working mode in response to the mode command carrying the working mode; and the working mode comprises the swing mode, the vibration mode and the oscillation mode; and
inputting the motor drive signal into the motor drive circuit to make the motor drive circuit drive the motor module to operate in the working mode.

8. The control method as claimed in claim 7, wherein when the working mode is the swing mode, the generating the motor drive signal corresponding to the working mode in response to the mode command carrying the working mode comprises:
obtaining a target low-frequency signal and a carrier signal, and generating a first motor drive signal according to the target low-frequency signal and the carrier signal; and
inputting the motor drive signal into the motor drive circuit to make the motor drive circuit drive the motor module to operate in the working mode, comprising:
inputting the first motor drive signal into the motor drive circuit; making the motor drive circuit respond to the first motor drive signal, and generating a first drive current; wherein the first drive current is configured to make a rotor of the motor module center on a balanced position and swing with a preset first swing amplitude and a preset first swing frequency.

9. The control method as claimed in claim 8, wherein when the working mode is the vibration mode, the generating the motor drive signal corresponding to the working mode in response to the mode command carrying the working mode comprises:
obtaining a target high-frequency signal and the carrier signal, and generating a second motor drive signal according to the target high-frequency signal and the carrier signal; and
inputting the motor drive signal into the motor drive circuit to make the motor drive circuit drive the motor module to operate in the working mode, comprising:
inputting the second motor drive signal into the motor drive circuit, making the motor drive circuit respond to the second motor drive signal, and generating a second drive current; wherein the second drive current is configured to make the rotor of the motor module center on the balanced position and vibrate at a preset first vibration amplitude and a preset first vibration frequency.

10. The control method as claimed in claim 8, wherein when the working mode is the oscillation mode, the generating the motor drive signal corresponding to the working mode in response to the mode command carrying the working mode comprises:
obtaining the target high-frequency signal, the target low-frequency signal and the carrier signal, superimposing the target high-frequency signal and the target low-frequency signal to obtain a target modulation signal, and generating a third motor drive signal according to the target modulation signal and the carrier signal; and
inputting the motor drive signal into the motor drive circuit to make the motor drive circuit drive the motor module to operate in the working mode, comprising:
inputting the third motor drive signal into the motor drive circuit, making the motor drive circuit respond to the third motor drive signal, and generating a third drive current; wherein the third drive current is configured to make the rotor of the motor module center on the balanced position, and swing the preset first swing amplitude and the preset first swing frequency, while making the rotor of the motor module center on a current swing position and vibrate at the preset first vibration amplitude and the preset first vibration frequency.
